(19) United States
(12) Patent Application Publication
(10) Pub. No.: US 2002/0184493 A1
(43) Pub. Date: Dec. 5, 2002

(54) Digital certificate expiry notification

(76) Inventor: Robert Thomas Owen Rees, Newport (GB)

Correspondence Address: HEWLETT-PACKARD COMPANY, Intellectual Property Administration, P.O. Box 272400, Fort Collins, CO, 80527-2400, US

(21) Appl. No.: 10/152,100

(22) Filed: May 21, 2002

(30) Foreign Application Priority Data
Jun. 4, 2001 (GB) 0113563.1

(51) Int. Cl. H04L 9/00

(52) U.S. Cl. 713/158

(57) ABSTRACT

A system for allowing a computer application or computer service to notify a user 10 that his certificate is within some specified interval before its expiry date utilizing information that is already contained in a standard digital certificate, together with current data information that is already known by the application 12 or service 16 to enforce expiry of the certificate when it occurs. No additional storage of information is required.

This invention relates to a method of digital certificate expiry notification and to apparatus for notifying a user of the expiry of digital certificate.

The use of digital certificates using public and private key encryption methods is widely known in the field of computing, particularly networked computing.

Typically, a digital certificate contains an expiry date, beyond which time the certificate is no longer valid. The certificate cannot then be used by the owner of the certificate to authenticate a request for information or a request for a transaction, which the certificate is intended to authenticate.

If the certificate expires before the owner of the certificate becomes aware that a fresh certificate is required, the owner will be denied access to facilities that require a certificate and that check the certificate's validity. These facilities include some websites and the ability to sign emails. obtaining a fresh certificate may take some time, because the issuing of a certificate should involve an identity check.

It is consequently a problem if the certificate expires before the user has been able to obtain the reissue of a certificate.

A user may explicitly check the expiry date of one of his certificates, because applications that use certificates generally have a method of conducting such inspection.

However, a check is a relatively tedious process that users would not undertake in the normal course of their use of certificates. Also, a user is likely to forget to check the expiry date at regular intervals.

Also, some certificate issuing systems (such as VeriSign OnSite) offer the option to send an email to a user at a defined time before a certificate provided by that issuer expires. Such a system requires not only that the issuer keep a record of all issued certificates, which it may do in any event for auditing purposes, but the issuer must also process its records regularly in order to identify soon to expire certificates. This is an additional cost of running a certificate issuing system. Given that this process is under the control of the issuer, the user cannot control whether or not they are notified, nor when or how the notification is issued.

It is an object of the present invention to address the above mentioned disadvantages.

A further object of the present invention is to provide an efficient method by which a user can be notified of the expiry of one or more of his digital certificates.

According to a first aspect of the present invention a method of notifying a computer user of the impending expiry of a digital certificate comprises:

causing a computer to compare an expiry date of the digital certificate with a current date, when a request for a service requiring authorisation is made; and

if the time to expiry is less than a predetermined threshold value, issuing a warning to the user that the threshold value has been passed.

The making of the comparison and issuing of a warning, if necessary, advantageously allows a user to have sufficient notification to allow him to obtain a re-issued certificate before expiry of a current certificate. Both pieces of information are already used in prior art systems, creating no extra storage requirements to implement the method. By checking the expiry date at the time of use of the certificate a separate system for making periodic checks is not needed.

The comparison of the expiry date with current date may be conducted by a computer application being run by the user, preferably on a computer operated by the user, or on a server. The comparison of the expiry date with the current date may be conducted by a service to which the user is making a request for service. The comparison may be made by both of the above.

The comparison may advantageously be made by either or both of a local computer operated by the user or a remote server operating the service requested.

The digital certificate may make use of public key encryption.

The user may be informed of a time until the threshold value is reached each time the certificate is used.

Thus the user is given a long period during which to consider renewal of the certificate.

The user may be able to set the predetermined threshold value. The threshold value may be set by a preference saving mechanism, such as by editing a computer file, which may be a cookie. The computer file may be stored by the user, preferably local to him.

The warning may be sent to the user by email. A user's email is typically included in a digital certificate, thus this type of warning may be used in all (or at least most) cases, if required.

The warning may be in the form of a separate page on a world wide web site to which a user is directed. The separate page may include a link back to the originally requested page. The separate page may include a link to a certificate re-issue/revalidation service.

The warning may be incorporated into a page on a world wide web site.

The warning is thus advantageously communicated to the user via a web browser he is using to access the service requiring a certificate.

The warning may be combined with a request for confirmation that a user wishes his certificate to be used. The warning may thereby be combined without an additional stage, because the request for confirmation is currently issued in prior art systems.

According to another aspect of the invention a method of informing a user of a computer of a future expiry of a digital security certificate comprises:

comparing with a computer an expiry date of the digital security certificate with a substantially current date, said comparison being made when a request for a service requiring authorisation with the digital security certificate is made; and

if a time to expiry of the digital security certificate is substantially less than a predetermined threshold value, informing the user of the computer that the threshold has been or soon will be passed by means of sending a computer message to the user.

According to a second aspect of the present invention, apparatus for notifying a user of the impending expiry of a digital certificate comprises:

a computer programmed to compare an expiry date of a digital certificate of the user with a current date when a request for a service requiring authorisation is made; the computer also being programmed to issue a warning to the user that a predetermined threshold value has been passed, if the time to expiry is less than the threshold value.

The computer may be programmed as an application for use by the user, preferably for personal use. The computer may be programmed as a server, preferably a world wide web server, for providing service to a plurality of users. Preferably said server is independent from the user.

The invention extends to a recordable medium bearing a computer program operable to carry out the method of the first aspect, in particular bearing a program operable to be used with an application run by the user.

All of the features disclosed herein may be combined with any of the above aspects, in any combination.

Specific embodiments of the present invention will now be described by way of example, and with reference to the accompanying drawings, in which:

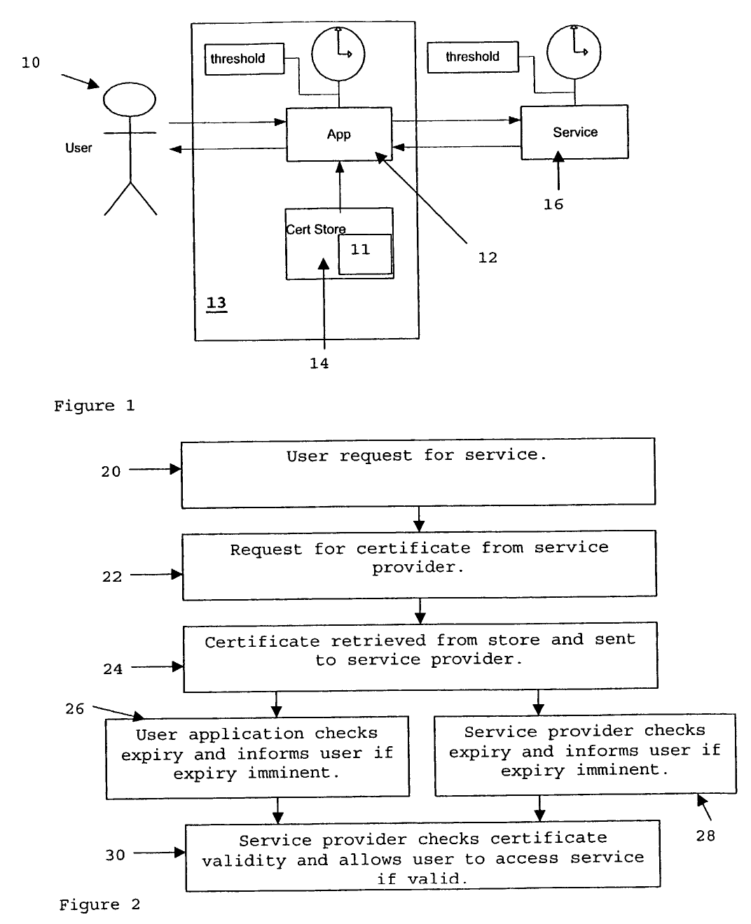

FIG. 1 is a schematic diagram of the components involved in an interaction between a user of a computer application that requests a service in need of a digital certificate; and

FIG. 2 is a schematic flow diagram of the interaction.

A system for allowing a computer application or computer service to notify a user that a certificate is within some specified interval before its expiry date utilises information that is already contained in a standard digital certificate, together with current date information that is already known by the application or service to enforce expiry of the certificate when it occurs. No additional storage of information is required. In addition, only a small amount of processing time is needed and only when the certificate is already being used or verified.

With reference to FIG. 1, when a user 10 wishes to make use of a computer application 12, such as a web browser or email client on a computer 13, the user 10 requests some action or service 16 that requires a certificate 11 of the user and the use of a private key associated with the user's certificate (box 20 in FIG. 2).

The service requested by the user 10 is typically remote from the user 10 and computer 13. The service may be access to information on a website for which the user 10 is asked to authenticate himself as the person named in a certificate 11, which certificate 11 has been obtained elsewhere (box 22 in FIG. 2). On prompting from the website web server, the application 12 retrieves the certificate 11 (and the public key if required) from a certificate store 14 (box 24 in FIG. 2), which may be on a server to which the user has access or on the disk of a local machine 13. The application 12 having retrieved the certificate 11 from the certificate store 14 sends it to the web server (even if the certificate 11 has expired).

In existing systems, the web server hosting the requested service compares an expiry date of the certificate with the current date to which it has access to check if the certificate 11 is still valid. If the certificate 11 has expired then the service 16 or action requested will not be allowed.

In the present system, however the application 12 compares the certificate expiry date with the current date and if the difference is less than some threshold value, the application 12 notifies the user 10 that the certificate 11 will expire in a given amount of time (box 26 in FIG. 2). The notification may typically be by means of a message or alert, possibly including an audible warning. The method described herein then follows with the step that the application 12 can be used to access the service 16 send the certificate 11 to that server. The service 16 then verifies that the certificate 11 is valid and uses it to authenticate the communication with the user (box 30 in FIG. 2).

In addition to the check mentioned above conducted by the application 12, the service 16 may compare the certificate expiry date with the current date and if the difference is less than a threshold value, it generates a notification to be returned to the user 10 (box 28 in FIG. 2). The is threshold value may be a parameter of the server 16 or it may be sent (e.g. as a cookie) with the request to the server 16.

It is common practice for the user to be asked to confirm use of the private key associated with a certificate, or, if there is more than one certificate available, to ask the user to select which certificate to use. The confirmation request or certificate selector may display the time left before the certificate expires, either always, with the highlight of a date and time when the threshold will be passed, or only when the threshold has actually been passed.

Where the application 12 is a web browser accessing a web 30 server, the web server may notify the user that the certificate is soon to expire, either by adding the warning into a server generated page, or by returning a separate warning page with links to take the user to the page originally requested.

The threshold value and the user preferences for notification may be incorporated into a cookie to allow a personalisation without the need for storage of that information by a server which runs the service 16. Where a service 16 cannot modify its response in order to deliver the notification, it may send a notification by other means. For example, the commonly used kind of certificate contains the users email address so that the service 16 may send notification by email. In this case a well designed service will include measures to avoid excessive repeated notifications.

The method and system described above can also be used for email applications to enable authenticated signature of emails, in addition to the uses described above in relation to websites.

A problem is also sometimes encountered in relation to email, if an email is sent in an encrypted form. If the certificate required for the reading of an email has expired, then the key required to decrypt the email may no longer be valid, given that the certificate has expired. A new key given with a new reissued certificate would not be able to access the encrypted email because the old (invalid) key is required. A solution to this problem would be to attach the certificate to the email, which even if the certificate has expired, may be used for a brief grace period after expiry of the certificate.

The implementation of the method is very simple in that the existing systems are already carrying out a test of whether the certificate has expired. Implementation of the system simply requires the posing of the question when will the certificate expire, together with action following the response to the question. At present a system will simply ask the question has the certificate expired. The threshold time period until expiry of the certificate may be set by the user, for example to one week in order to give the user sufficient time to obtain reissue of the certificate at a time convenient to them. This information may be stored in a cookie which may include such information as whether the user wants a warning and if so, what period should be used. On is initiating the system with the service 16 the server driving the service 16 sends the user 10 a cookie bearing details that have been entered by the user 10 concerning his requirements. The user 10 then sends the cookie to the service 16 each time it is used. Consequently, there 20 is no need for a server running the server 16 to store the user's preferences.

The method and system described above will make use of the date of expiry in conjunction with the current date, both of which pieces of information are already known by a user computer running his application 12 and also by a server running a service 16 with which he is communicating. Consequently, the method and system is very simple to implement by a person skilled in the art. Thus, in order to ensure a continuous service the user 10 is warned in enough time to obtain a new certificate before the old one expires. Consequently, given that it may take approximately half an hour to renew a certificate for a user on a network with a particular institution and that it may take considerably longer to renew a certificate with an external organisation, much time is saved by the system of issuing warnings.

1. A method of notifying a computer user of the impending expiry of a digital certificate comprises:
causing a computer to compare an expiry date of the digital certificate with a current date, when a request for a service requiring authorisation is made; and
if a time to expiry is less than a predetermined threshold value, issuing a warning to the user that the threshold value has been passed.

2. A method as claimed in claim 1, in which a comparison of the expiry date with the current date is conducted by a computer application being run by the user, on a computer operated by the user or on a server.

3. A method as claimed in claim 1, in which a comparison of the expiry date with the current date is conducted by a service to which the user is making a request for service.

4. A method as claimed in claim 1, in which the user is informed of a time until the threshold value is reached each time the certificate is used.

5. A method as claimed in claim 1, in which the user is able to set the predetermined threshold value by a preference saving mechanism.

6. A method as claimed in claim 1, in which the warning is sent to the user by email.

7. A method as claimed in claim 1, in which the warning is in the form of a separate page on a world wide website to which a user is directed.

8. A method as claimed in claim 1, in which the warning is incorporated into a page on a world wide website.

9. A method as claimed in claim 1, in which the warning is combined with a request for confirmation that a user wishes his certificate to be used.

10. A method of informing a user of a computer of a future expiry of a digital security certificate comprises:
comparing with a computer an expiry date of the digital security certificate with a substantially current date, said comparison being made when a request for a service requiring authorisation with the digital security certificate is made; and
if a time to expiry of the digital security certificate is substantially less than a predetermined threshold value, informing the user of the computer that the threshold has been or soon will be passed by means of sending a computer message to the user.

11. Apparatus for notifying a user of impending expiry of a digital certificate comprises:
a computer programmed to compare an expiry date of a digital certificate of the user with a current date when a request for a service requiring authorisation is made;
the computer also being programmed to issue a warning to the user that a predetermined threshold value has been passed, if a time to expiry is less than the threshold value

12. Apparatus as claimed in claim 11, in which the computer is programmed as an application for use by the user.

13. Apparatus as claimed in claim 11, in which the computer is programmed as a server for providing service to a plurality of users.

14. A recordable medium bearing a computer program operable to carry out the method claimed in claim 1.
